(19) United States
(12) Patent Application Publication
(10) Pub. No.: US 2011/0033349 A1
(43) Pub. Date: Feb. 10, 2011

(54) Pipette or Dispenser with Piston Position Display

(76) Inventors: Peter Schmidt, Lubeck (DE); Karl-Friedrich Andres, Bargteheide (DE); Peter Molitor, Hamburg (DE)

Correspondence Address: WHITE & CASE LLP;PATENT DEPARTMENT, 1155 AVENUE OF THE AMERICAS, NEW YORK, NY, 10036, US

(21) Appl. No.: 12/676,184

(22) PCT Filed: Sep. 8, 2008
(86) PCT No.: PCT/EP2008/007329

§ 371 Date: Oct. 26, 2010

(30) Foreign Application Priority Data
Sep. 7, 2007 (DE) 10 2007 042 555.6

(51) Int. Cl. G01N 35/10

(52) U.S. Cl. 422/919

(57) ABSTRACT

According to the invention, a pipette or a dispenser (10) with a piston indicator (6) is characterized in that a display (2) shows the piston position (20).

The present invention relates to a dosing system being a pipette or a dispenser with a display showing the piston position.

As is known, pipettes are used to take up or aspirate and subsequently release an exactly definable and usually small amount of liquid. Known pipette designs usually have an elongate shape, with a shaft-shaped grip that the user holds in his hand, and with a pipetting end, the so-called (usually exchangeable) pipette tip, for taking up and releasing the amount of liquid at the lower end of the pipette that protrudes downward from the user's “fist” during pipetting, and with at least one pipette-actuating element at the upper end of the pipette, where it can be actuated by the user's thumb.

In mechanical pipettes, the mechanical drive of the piston gives the user a direct feel for the actuated travel of the pipette piston and therefore also for the piston position. In electrically operated pipettes, none of this direct information is available to the user. It is true that electronic pipettes are already known in which the direction of the piston movement is shown on the display. However, this display is situated outside the user's field of view during handling of the pipette and is instead in most cases covered by the user's hand gripping the pipette.

Dispensers differ from pipettes generally by serving for repetitive liquid dispensing: By use of a dispenser, the liquid volume can be dispensed as several portions consecutively. Preferably, the respective portions have the same volume. In contrast by use of a pipette, the liquid volume is dispensed as one defined volume.

The object of the present invention is to make available a pipette or a dispenser with which precise information concerning the position of the piston is provided directly to the user independently of the nature of the piston drive (electrical or mechanical).

This object is achieved by a dosing system being a pipette or a dispenser and having the features of claim 1. Preferred embodiments are set forth in the dependent claims.

According to the invention, a dosing system being a pipette or a dispenser, for example with a piston driven mechanically or by an electric motor, is equipped with a piston position display. According to the invention, this can be arranged as an LCD or mechanical display on the dosing system in such a way that it is oriented toward the user's face during handling. In known pipette or dispenser designs, this is preferably, according to the invention, in the area of the lower end of the grip, on which end the user's attention is concentrated for observation and precise positioning of the pipette or dispenser tip during use.

In order to permit a piston position display without current, particularly for pipettes or dispensers with mechanical driving of the piston, a dosing system according to the invention can have a mechanical transmission mechanism for the piston position display.

These and other aspects of the present invention are described in more detail below with reference to the attached drawings in which illustrative embodiments of the invention are depicted.

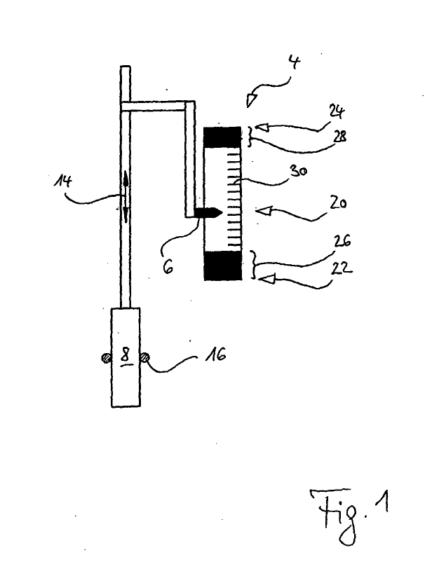

FIG. 1 shows a schematic view of the mechanism of a mechanical piston position display according to the invention, and

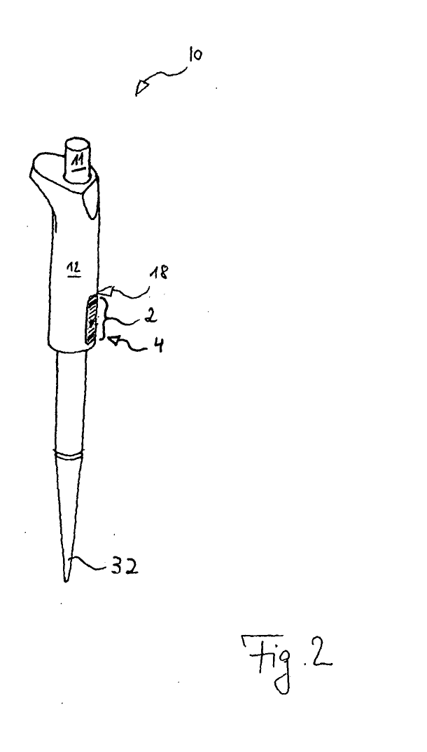

FIG. 2 shows a schematic perspective view of a pipette according to the invention with a piston position display.

FIG. 1 shows a mechanical piston position display 2 with a scale 4, and with an indicator 6 which is directly connected mechanically to the piston 8 of a pipette 10 (now also with reference to FIG. 2).

As is generally known for pipettes, the piston 8 is moved in the axial direction (indicated by the arrows 14 in FIG. 1) by an actuating element 11 at the upper end of the shaft-like grip 12 and, in so doing, it slides in a sealing ring 16. Alternatively, the sealing ring 16 can also be an element of the piston 8 and can slide in the correspondingly configured pipette chamber (not shown). The scale is connected in a fixed position to the housing 18 of the pipette 10, while a mechanical transmission mechanism ensures that the piston 8, during its movement 14, entrains the indicator 6, which is rigidly connected to it. The indicator 6 thus follows the piston movement directly and in any event by the same distance and in the same direction. The indicator 6 can thus show, on the scale 4, the “piston position” 20 relative to the “lower end position” 22 and the “upper end position” 24. In the example depicted here, the areas “blow-out” 26 and “reverse stroke” 28 near the end positions 22, 24 are also marked. Scale graduations 30 facilitate accurate reading of the exact piston position 20 shown by the indicator 6.

The markings in the area of the upper end position 24, 28 are required for dispensing in particular with an electronic and/or motorized pipette. For such pipettes, electronic displays are particularly suitable since they permit simple programming of a deliberately disproportionate presentation of the piston travel, for example for exaggerated illustration or magnified indication of a defined (or definable) partial path of the piston travel.

The scale 4 can also be modifiable (not shown). For example, in the case of a variable mechanical pipette that is also able to dispense, the markings 24 and 28 can be displaceable, such that they can be moved to the appropriate position, for example by a rotary movement of the selector wheel for volume selection (and such that, for example, an area of the scale that is then not relevant is also hidden by a screen). For example, when a volume reduction is set, the markings 24 and 28 move downward in FIG. 1 and, when the volume is increased, they move upward again.

Referring to FIG. 2, it will be seen that the scale 4 is arranged in the area of the lower end of the grip 12 of the pipette 10 in such a way that it is oriented toward the user's face (not shown) during handling of the pipette 10, and the user is easily able to read off the scale 4, particularly without having to change the position of his hand or of the pipette 2 or of his head, while his attention is concentrated on the pipette tip 32 at the lower end of the pipette 10 during the pipetting or dispensing procedure. The resulting advantage is that the reading-off of the piston position does not in any way divert the user's concentration from the pipetting procedure.

As has been described with reference to FIG. 1, the indicator 6 is rigidly connected to the piston 8, such that in this embodiment of the invention the scale 4 has to be oriented in the same direction as the piston movement 14. By fitting known rocker mechanisms (not shown) for example, it is easy to design the pipette such that the scale 4 can also be oriented at another angle with respect to the direction of the piston movement 14.

1. A dosing system comprising a pipette or a dispenser, a piston and an electronic piston position display, wherein the electronic piston position display comprises a piston indicator and is capable of a disproportionate presentation of the position of the piston relative to piston displacement.

2. The dosing system according to claim 1, wherein the electronic piston position display is an LCD.

3. The dosing system according to claim 1, wherein the electronic piston position display is arranged such that it is oriented toward the user's face during handling of the pipette or dispenser.

4. The dosing system according to claim 3, wherein the pipette or dispenser comprises a grip, and wherein the electronic position display is arranged in the area of the lower end of the grip.

5. The dosing system according to claim 1, further comprising a mechanical transmission mechanism for displaying the position of the piston.
